(19) United States
(12) Patent Application Publication
(10) Pub. No.: US 2011/0125549 A1
(43) Pub. Date: May 26, 2011

(54) LONG-TERM MOVING AVERAGE WEEKLY FORECAST TOOLS AND TECHNIQUES

(75) Inventors: SOPHIE MERLE, Eaubonne (FR); DAVID PASQUIER, La Ville aux Clercs (FR); PASCAL FISCHER, Montigny le Bretonneux (FR)

(73) Assignee: ORACLE INTERNATIONAL CORPORATION, Redwood Shores, CA (US)

(21) Appl. No.: 12/625,490

(22) Filed: Nov. 24, 2009

(51) Int. Cl. G06Q 10/00

(52) U.S. Cl. 705/7.29

(57) ABSTRACT

A method of determining a long-term forecast for a particular week can include identifying a week type of the particular week, identifying a number of prior weeks having the same week type as that of the particular week, retrieving driver data for each of the prior weeks, and averaging the retrieved driver data.

### BACKGROUND

Workforce scheduling applications (WSAs) such as Oracle® Workforce Scheduling have been developed over the years to help organizations accurately forecast and schedule their workforce to meet various customer service and cost objectives. WSAs can be used to optimize workforce management by optimizing staffing schedules, positively impacting customer satisfaction, driving sales, and reducing operating costs. For example, staffing schedules based upon peak periods often lead to increased customer satisfaction. Managers may use a WSA to produce a weekly labor schedule in minutes rather than doing so manually, which often takes several days. This provides the managers with more time to spend with customers.

Another benefit many WSAs offer managers is the ability to track key performance indicators (KPIs) that provide visibility into the status of revenue, scheduling, and staff productivity. KPIs may include, but are not limited to, dollar-based values such as initial and current budget, last year actual, variance to budget, and variance to last year. KPIs may also include various time-based values such as initial and current budget, demand, scheduled amount, earned amount, actual, last year actual, adjusted budget variance, variance to last year, and additional budget or scheduled.

While current forecast and demand planning features generally incorporate a statistical analysis engine used to forecast pertinent values, such an engine has several limitations. For example, current statistical analysis engines do not provide a smoothed forecast for extended intervals of time, particularly intervals that may span over a full year.

### BRIEF DESCRIPTION OF THE DRAWINGS

FIG. 1 illustrates an example of a long-term moving average weekly forecast system in accordance with implementations of the disclosed technology.

FIG. 2 illustrates a first example of a machine-controlled method of determining a long-term weekly forecast for a particular week in accordance with implementations of the disclosed technology.

FIG. 3 illustrates a second example of a machine-controlled method of determining a long-term weekly forecast for a particular week in accordance with implementations of the disclosed technology.

FIG. 4 illustrates a more detailed example of a machine-controlled method of determining a long-term weekly forecast for a particular week in accordance with implementations of the disclosed technology.

### DETAILED DESCRIPTION

Embodiments of the disclosed technology may include a long-term scheduling feature for a workforce scheduling application (WSA) such as Oracle® Workforce Scheduling or other suitable application. A long-term scheduling feature may enable users such as store managers to generate an optimized weekly schedule up to a year in advance. Managers may strategically match their workforce resources with the actual or anticipated workload and produce workforce schedules that take into account events such as employee absences and federal holidays, for example.

Certain embodiments of the disclosed technology may include calculating a number of hours worked each week per activity based on a particular driver's forecasts. A driver, as used here, refers to a particular business-related category such as sales, store traffic, number of transactions, and number of shipments or crates received, for example. Driver data refers to data pertaining to a particular driver such as sales. A WSA in accordance with the disclosed technology may, at startup, establish a list of algorithms that the WSA may use to forecast the applicable drivers to determine a forecasted value for each week of the year.

Certain embodiments of the disclosed technology may include characterizing some or all of the weeks of a particular year, such as the current calendar year, by assigning each week a certain week type. There can be virtually any number of different week types such as “Normal Week” for weeks having no particular activity associated therewith, “Holiday Week” for weeks that contain a federal, company, or other holiday, and “Vacation Week” for weeks in which many employees are expected to request vacation time, for example.

Certain implementations may include using a long-term “moving average” algorithm as part of a weekly scheduling tool. In these embodiments, the moving average algorithm may calculate a moving average of the history of the last n weeks leading up to the week to be forecast, where each of the n weeks have the same week type as the week to be forecast, such as “vacation week.” As used here, n represents a whole-number parameter that a user may define during the WSA setup stage and that may be modified at a later point in time.

In certain embodiments, n may represent a maximum number of potential weeks used in determining a long-term weekly forecast. For example, if n is set to thirty but there are thirty-five weeks having the same week type as the week to be forecast, the system may select the most recent thirty of the thirty-five weeks. Alternatively, if n is set to thirty but there are only twenty-five weeks having the same week type as the week to be forecast, the system may apply the averaging techniques to the twenty-five weeks and alert the user that the system was unable to identify n weeks having the particular week type.

Historical driver data, as used here, represents real values of drivers that the system has recorded and imported into the WSA at the end of the corresponding week. Historical driver data is generally stored within a system database or at a remote data storage unit. Historical driver data may be stored in perpetuity or until a specific expiration date, at which point the historical driver data may be erased, depending on the particular system.

Actual driver data, as used herein, refers to current or real driver values that the system has stored but has not yet imported into the WSA and, therefore, has not yet become historical driver data. The data may be used to calculate earned hours, for example. Actual driver data is generally stored locally though in certain arrangements it may be stored remotely. Once actual driver data has become historical driver data by being imported into the WSA, however, it may be stored locally, remotely, or both.

Standard forecast driver data or standard future driver data, as used here, refers to projected driver data determined by conventional means. Standard forecast driver data cannot be actual driver data because standard forecast driver data corresponds to weeks that have not yet taken place and, therefore, have not yet yielded any actual driver data. Standard forecast driver data may have been previously generated and stored locally or remotely, for example. Standard forecast driver data may not exist for a particular week, however. For those weeks, the system may dynamically calculate the standard forecast driver data for that week by applying a standard forecast algorithm, for example.

Certain embodiments may include performing the moving average computation of the last n weeks' data by determining whether each of the n weeks has associated therewith historical driver data, actual driver data, or standard forecast driver data. If historical driver data is available, the system may use the historical driver data in calculating the average. If historical driver data is not available but actual driver data is available, the system may use the actual driver data. If historical and actual driver data are both nonexistent for a certain one of the n weeks, the system may use existing standard forecast driver data or dynamically generate standard forecast driver data and then use that data in the averaging calculation.

By averaging historical, actual, and/or standard forecast data over a long period of time such as a full year, the system can calculate a smoothed long-term forecast for each week of the year. The calculated values become even more accurate over time because each time a long-term forecast technique is subsequenly invoked, the calculated driver data are recorded and made available for future calculations. Store managers can use the driver forecast tool to deduce the number of hours per activity, for example, and are enabled to generate a significantly more optimized schedule.

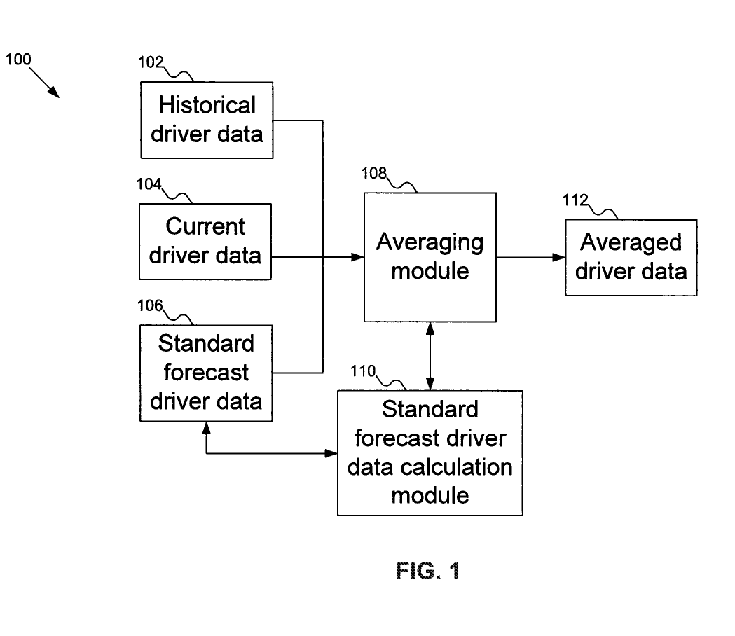

FIG. 1 illustrates an example of a long-term moving average weekly forecast system 100. In the example, an averaging module 108 determines averaged driver data 112 in order to determine a long-term forecast for a given week. The week may be selected by a user or automatically selected by the system 100. In certain embodiments, the system 100 may determine a long-term forecast for each week within a specified time period such as the calendar year, a fiscal year, or some other user-specified year interval, for example.

Each pertinent prior week to be evaluated by the system 100 in calculating the long-term forecast for the week to be forecast may have associated therewith historical driver data 102, current/actual driver data 104, and standard forecast driver data 106. For example, if the pertinent prior week has not yet taken place, the week will not have any historical driver 102 or actual driver data 104. The pertinent prior week may or may not have any standard forecast driver data 106 associated therewith.

If the system 100 had previously generated standard forecast driver data 106 for the pertinent prior week, the system can retrieve such data and provide it to the averaging module 108 to be used in the long-term forecast calculation. If the week to be evaluated does not have any standard forecast driver data 106, however, a standard forecast driver data calculation module 110 can be used to optionally generate the standard forecast driver data 106 to be provided to the averaging module 108.

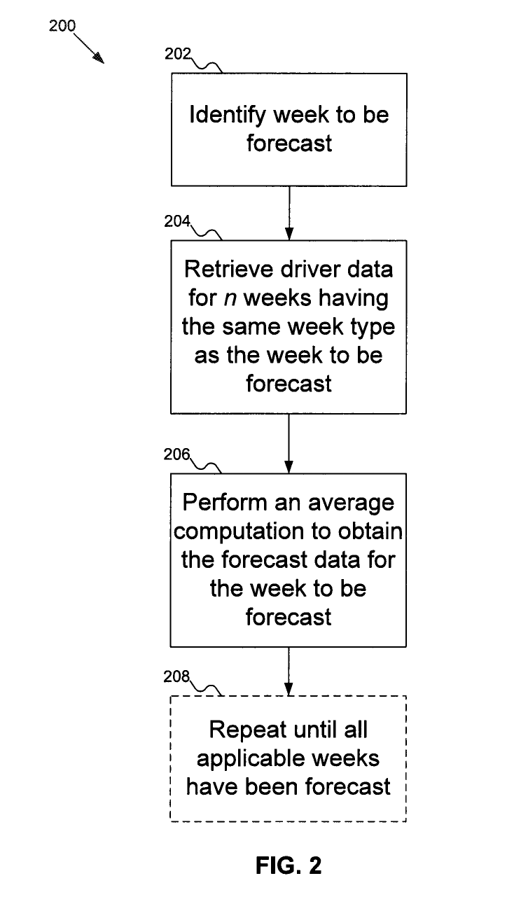

FIG. 2 illustrates a first example of a machine-controlled method 200 of determining a long-term forecast for a particular week. At 202, a week to be forecast is identified. For example, a user may select a particular week via a WSA interface. In certain embodiments, the system may be set to automatically select the week to be forecast such as the current week or the next upcoming week having the same week type as the current week.

At 204, driver data is retrieved for each of n weeks prior to the week to be forecast that each have the same week type as the week to be forecast. In certain embodiments, the system looks for the n weeks back to a particular start date, such as the week that is one year prior to the week to be forecast.

At 206, the system performs an averaging computation by applying an averaging algorithm to the retrieved driver data to obtain long-term forecast data for the week in question. For example, the system may sum together all of the retrieved driver data values and divide by the number of the n weeks that have the same week type as the week to be forecast. In certain embodiments, the system may apply a more complicated algorithm such as one that may weigh weeks differently depending on any of a number of possible reasons, such as time of year or season.

At 208, the system repeats steps 204 and 206 for each applicable week. For example, if the system is directed to determine a long-term forecast for each week of the coming fiscal year, the system will perform steps 204 and 206 for each week starting with the first week of the coming fiscal year and ending with the last week of the coming fiscal year. As any given week is long-term forecasted, the data may be stored in association with that week such that the system may retrieve it and use it while long-term forecasting weeks that occur after the given week.

Consider an example in which a user chooses the system date, which is May 7, 2009. The calendar year begins on Jan. 1, 2009. Because the first week to be forecast is typically the maximum between the system date and the first week of the selected year, the system will calculate the weekly forecast from the system date of May 7, 2009 to the end of the calendar year, Dec. 31, 2009. For each week to be forecast, the system will search each week of the same week type up to one year in the past, looking for historical, actual, or standard forecast driver data. If no such data exists, the system may generate standard forecast driver data for the week in question.

For each week having the same week type as the week to be long-term forecast, the system may perform the average in accordance with the following directives. If historical driver data exists for the given week, the system will apply the historical driver data. If there is no historical driver data for the week but there is actual driver data, the system will apply the actual driver data. If neither historical nor actual driver data exists, however, the system will apply standard forecast driver data. The system can apply stored standard forecast data if available or, if such data does not yet exist, the system can dynamically generate the standard forecast data to be applied in the average computation.

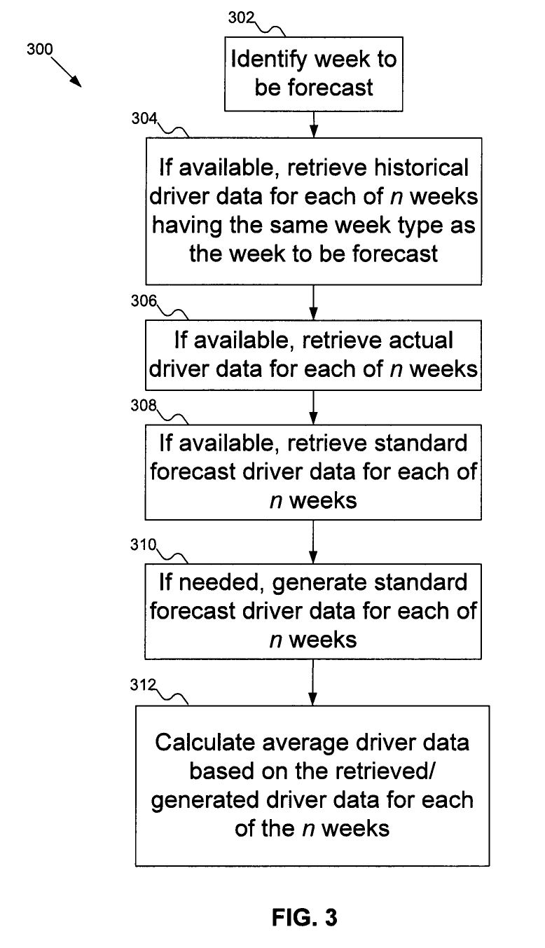

FIG. 3 illustrates a second example of a machine-controlled method 300 of determining a forecast for a particular week. At 302, a week to be forecast is identified. This step is similar to step 202 of FIG. 2.

At 304, the system first attempts to retrieve historical driver data for each of n weeks prior to the week to be forecast that have the same week type as the week to be forecast. For example, if the week to be forecast is of the type “holiday week,” the system will seek to retrieve historical driver data for all weeks of type “holiday week” with the n weeks. If the week in question has not yet occurred, the system may be directed to bypass this step and proceed directly to step 306. The system may also proceed directly to step 306 if there is historical driver data for the week but the system is unable to retrieve it because such data is unavailable or corrupted, for example.

At 306, the system seeks to retrieve actual driver data for the week in question. If the week in question has not yet occurred, however, the system may be directed to bypass this step and proceed directly to step 308. The system may also proceed directly to step 308 if there is actual driver data for the week but the system is unable to retrieve it because such data is unavailable or corrupted, for example.

At 308, the system seeks to retrieve standard forecast driver data for the week in question. If the week in question has already occurred, however, the system likely retrieved either historical driver data at 304 or actual driver data at 306 and has been directed to skip this step. If the week has not yet occurred or if the system was unable to retrieve historical driver data and actual driver data for the week, however, the system will look for any previously generated standard forecast data. If such standard forecast data cannot be found, the system can dynamically generate standard forecast data for the week, as shown at 310.

Once the system has retrieved all of the historical, actual, and/or standard forecast driver data for the n weeks having the same week type as the week to be forecast, the system applies an averaging algorithm to the retrieved driver data to obtain an averaged driver value for the week, as shown at 312. In certain embodiments, the system sums all of the retrieved data values and divides the sum by the number of the n weeks for which the system retrieved the data values. The final value can be provided as output to a WSA, for example, for use in scheduling activities and other processes in connection with the WSA.

Consider another example in which the second week of July, which is designated a “vacation week,” is to be long-term forecast using a moving average computation. The system can first search all weeks designated as “vacation weeks” within the year leading up to the week in question. In the example, the system identifies five weeks of type “vacation week.” The first identified week is the first week of July, for which no historical, actual, or forecast driver data exists. The system may generate forecast data for that week.

The next identified weeks are the first two weeks of May. Neither week has historical driver data associated with it. Both weeks, however, have actual driver data stored locally. The system may use the actual driver data for each of the two weeks in question. The final identified weeks are the third and fourth weeks in December, both of which have historical driver data stored remotely. The system may retrieve and use the historical driver data in performing the averaging computation for the week to be forecast.

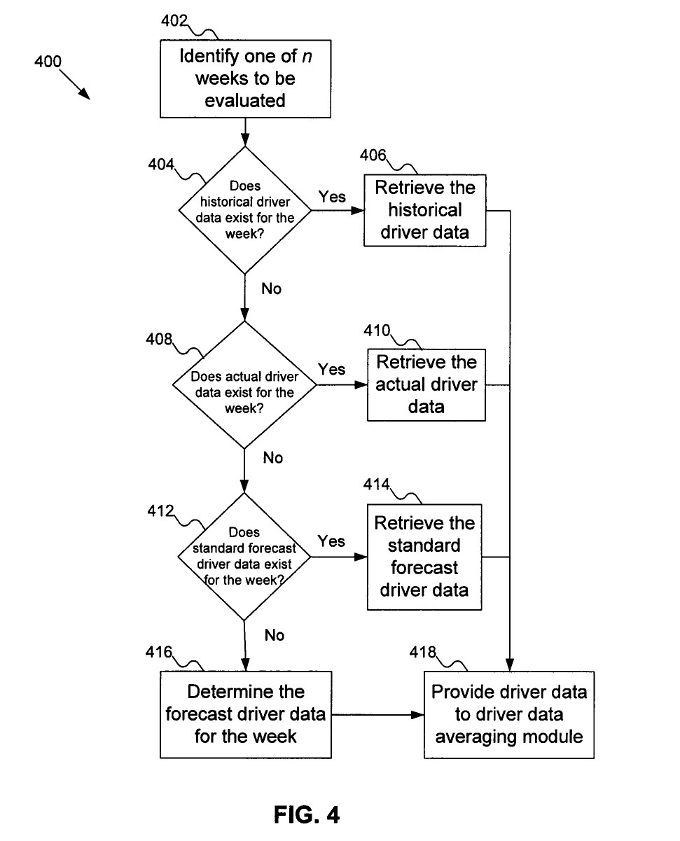

FIG. 4 illustrates a more detailed example of a machine-controlled method 400 of determining a forecast for a particular week. Once the particular week has been identified by a user or by the system itself, for example, the system identifies n weeks that each the same week type as the week to be forecast. In certain embodiments, the system may process each of the n weeks in chronological or reverse-chronological order.

Once the system selects one of the n weeks to evaluate, as shown at 402, the system determines whether any historical driver data exits for the week being evaluated, as shown at 404. If such historical driver data exists, the system retrieves the data as shown at 406 and provides the data to a driver data averaging module, as shown at 418. If historical driver data does not exist for the week being evaluated or is unable to be retrieved, the system proceeds to 408.

At 408, the system determines whether any actual driver data exists for the week being evaluated. If actual driver data exists, the system retrieves the data as shown at 410 and provides the data to the driver data averaging module, as shown at 418. If actual driver data does not exist for the week being evaluated, or if the data exists but is not retrievable because it has been corrupted, for example, the system proceeds to 412.

At 412, the system determines whether any standard forecast driver data exists for the week being evaluated. If standard forecast driver data exists, the system retrieves the data as shown at 414 and provides the data to the driver data averaging module, as shown at 418. If standard forecast driver data does not exist for the week being evaluated, however, the system proceeds to 416.

At 416, the system can dynamically generate standard forecast driver data for the week being evaluated and then provide the data to the driver data averaging module, as shown at 418. The dynamic generation of standard forecast driver data for the week being evaluated, as shown at 416, is an optional feature that can be excluded from certain implementations. For embodiments that include this feature, the system can implement virtually any currently available standard forecast tool to dynamically generate the standard forecast driver data for the week being evaluated. Once the averaging module has received all of the application weekly data, the module may generate an average driver data value for the current one of the n weeks using any of the techniques described above.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Examples may include computing devices such as personal computers, workstations, servers, portable computers, handheld devices, tablet devices, and the like.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like. The machine can be controlled, at least in part, by input from conventional input devices (e.g., keyboards and mice), as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, physical storage media.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

We claim:

1. A machine-controlled method of determining a long-term forecast for a particular week, comprising:
identifying a week type of the particular week;
identifying a plurality of prior weeks, wherein each of the plurality of prior weeks has a week type that is substantially identical to the week type of the particular week, and wherein each of the plurality of prior weeks takes place prior to the particular week;
retrieving driver data for each of the plurality of prior weeks; and
determining an average of the retrieved driver data.

2. The machine-controlled method of claim 1, wherein retrieving driver data for at least one of the plurality of prior weeks comprises retrieving stored historical driver data for the at least one of the plurality of prior weeks.

3. The machine-controlled method of claim 1, wherein retrieving driver data for at least one of the plurality of prior weeks comprises retrieving stored actual driver data for the at least one of the plurality of prior weeks.

4. The machine-controlled method of claim 3, wherein retrieving the stored actual driver data is responsive to a determination that historical driver data is not available for the at least one of the plurality of prior weeks.

5. The machine-controlled method of claim 1, wherein retrieving driver data for at least one of the plurality of prior weeks comprises retrieving stored standard forecast driver data for the at least one of the plurality of prior weeks.

6. The machine-controlled method of claim 5, wherein retrieving the stored standard forecast driver data is responsive to a determination that no historical driver data or actual driver data is available for the at least one of the plurality of prior weeks.

7. The machine-controlled method of claim 1, wherein retrieving driver data for at least one of the plurality of prior weeks comprises dynamically generating standard forecast driver data for the at least one of the plurality of weeks.

8. The machine-controlled method of claim 1, wherein dynamically generating the standard forecast driver data is responsive to a determination that there is no stored standard forecast data available for the at least one of the plurality of prior weeks.

9. The machine-controlled method of claim 1, wherein the week type is one of a group consisting of “normal week,” “holiday week,” and “vacation week.”

10. The machine-controlled method of claim 1, wherein the driver data comprises data pertaining to one of a group consisting of sales, store traffic, number of transactions, and number of crates received.

11. One or more tangible computer-readable media storing instructions that, when executed by a processor, cause a computer to perform the machine-controlled method of claim 1.

12. A machine-controlled method, comprising:
receiving an identification of a week to be forecast;
determining a week type of the week to be forecast;
identifying a prior week having the same week type as the week to be forecast;
retrieving one of historical driver data, actual driver data, and standard forecast driver data corresponding to the prior week;
repeating the identifying and retrieving for each of n prior weeks; and
providing the retrieved driver data to a driver data averaging module.

13. The machine-controlled method of claim 12, further comprising the driver data averaging module calculating an average value based on the retrieved driver data.

14. The machine-controlled method of claim 12, wherein n is a whole-number parameter initially determined at a system startup.

15. The machine-controlled method of claim 12, wherein n has a value no greater than fifty-two.

16. The machine-controlled method of claim 12, wherein the week to be forecast is a first week of a fiscal year.

17. The machine-controlled method of claim 12, wherein the week to be forecast is a first week of a calendar year.

18. A weekly forecast system, comprising:
a driver data retrieval module operable to retrieve driver data for each of a plurality of weeks prior to a week to be forecast, wherein the driver data is one of a group consisting of historical driver data, actual driver data, and standard forecast driver data for each of the plurality of weeks prior to the week to be forecast; and
a driver data averaging module operable to determine a long-term weekly forecast based on the retrieved driver data.

19. The weekly forecast system of claim 18, further comprising a standard forecast driver data generation module operable to dynamically generate standard forecast driver data for at least one of the plurality of weeks prior to the week to be forecast.
